(19) United States
(12) Patent Application Publication
(10) Pub. No.: US 2026/0225722 A1
(43) Pub. Date: Aug. 6, 2026

(54) POWER SHARING IN AN AIRCRAFT USING DISTRIBUTED CONTROL

(71) Applicants: SAFRAN, Paris (FR); SAFRAN ELECTRICAL & POWER, BLAGNAC (FR)

(72) Inventors: Florent Jean-Arnaud ROUGIER, MOISSY-CRAMAYEL (FR); Geoffrey BEGGIORA, MOISSY-CRAMAYEL (FR); Guillaume François Daniel BIDAN, MOISSY-CRAMAYEL (FR); Anne Marie LIENHARDT, MOISSY-CRAMAYEL (FR)

(73) Assignees: SAFRAN, Paris (FR); SAFRAN ELECTRICAL & POWER, BLAGNAC (FR)

(21) Appl. No.: 19/151,734

(22) PCT Filed: Feb. 2, 2024
(86) PCT No.: PCT/FR2024/050137

§ 371 Date: Jul. 29, 2025

(30) Foreign Application Priority Data
Feb. 3, 2023 (FR) FR2301037

(51) Int. Cl. B64D 27/35; B64D 27/33; B64D 31/18; B64D 35/022; H02J 1/10; H02J 1/102

(52) U.S. Cl. CPC B64D 27/35; B64D 27/33; B64D 31/18; B64D 35/022; H02J 1/102; H02J 1/106

(57) ABSTRACT

A system for exchanging power in an aircraft includes voltage bus, a low-pressure and high-pressure electromechanical converters, and for each electromechanical converter, a voltage control module. The system further includes a computer providing a sharing setpoint between the exchanged powers, the sharing setpoint varying over time; and for at least one of the electromechanical converters: a module that ensures the sharing setpoint is observed. The module is configured to adjust the power that is exchanged by the relevant electromechanical converter in order to observe the received sharing setpoint, taking into account a received evaluation of the power exchanged by the other of the electromechanical converters.

### TECHNICAL FIELD OF THE INVENTION

The present invention relates to a power exchange installation in an aircraft, a propulsion system of an aircraft comprising such an installation, an aircraft comprising such a propulsion system, as well as a corresponding method.

### TECHNICAL BACKGROUND

In a context of reducing the ecological footprint of the aircrafts, hybrid electric power appears to be a technological solution that may significantly improve the environmental performance of the aircrafts, in particular by reducing their fuel consumption.

It is known in the prior art that power exchange installations in an aircraft comprise:
a voltage bus designed to present a bus voltage;
a low-pressure (BP) electromechanical converter designed to exchange power between the voltage bus and a low-pressure body of a turbomachine of the aircraft;
a high-pressure (HP) electromechanical converter designed to exchange power between the voltage bus and a high-pressure body of the turbomachine of the aircraft; and
for each electromechanical converter, a voltage control module, designed to control the bus voltage by controlling the electromechanical converter in question so as to adjust the power exchanged.

The voltage bus is generally part of an electrical network of the aircraft, this electrical network may also comprise sources and/or loads connected to the voltage bus.

In this way, the electromechanical converters form an interface between the HP and BP bodies of the turbomachine and the electrical network of the aircraft.

To ensure the correct operation of the loads in particular, the bus voltage must remain within a predefined range, which is made possible by the bus voltage control modules respectively associated with the electromechanical converters.

These control modules may have a zero static bus voltage error, which has the advantage that the bus voltage remains very close to its setpoint. However, these two controls of the bus voltage are independent of each other and may compete with each other, leading to a drift in power sharing, with one electromechanical converter exchanging all the power and the other none at all.

One of the solutions to this problem proposed in the prior art is a so-called “decentralized” installation implementing a droop control to define the power split between the power exchanged by the low-pressure body and the power exchanged by the high-pressure body, by defining appropriate droop coefficients. However, the bus voltage control modules then have a non-zero static error, so that the bus voltage remains far from its setpoint, which may lead it to go out of range when power is called up by a load on the electrical network or when power is supplied by a source.

In addition, the control of the power sharing is highly dependent on the accuracy of the bus voltage measurement and requires a highly accurate acquisition chain (<1% error).

Alternatively, one of the two electromechanical systems should control the bus voltage and the other system should apply a power draw or power input setpoint coming from the central computer.

However, this solution has the disadvantage of not being robust to the loss of the electromechanical system controlling the bus voltage. The other system may reconfigure itself, but there will be a loss of network over a long period of time, electrically speaking. In addition, the central computer must constantly send a setpoint to the system not performing the voltage control.

Another solution in the prior art is to propose a so-called “centralized” installation, where an external computer performs the control of the bus voltage and applies or does not apply a power draw or input setpoint coming from the central computer and distributes the power or torque setpoints to the two electromechanical converters.

This system has the advantage of being robust to the loss of one of the two electromechanical converters. The two electromechanical converters may then control the voltage and share the power to be drawn.

However, the dependency between the centralized computer and the two electromechanical converters requires the addition of a fast communication (greater than 10 kHz).

Furthermore, the Japanese patent application published under the number JP 2014 131469 A describes two generators coupled to a turbomachine, and two controllers for respectively controlling these two generators. Each controller is designed to receive a power ratio setpoint and the ratio of the current supplied by the associated generator with respect to the total current supplied by the two generators. This ratio is calculated from measurements of the current supplied by each of the generators. Each controller is designed to supply, to the associated generator, a voltage setpoint that the generator must supply, calculated by the value of a resistance calibrated in an output filter, which requires an accurate knowledge of this resistance value, difficult to obtain due in particular to variations in the environment (temperature, etc.). The U.S. Pat. No. 11,355,929 is substantially similar, except that it does not describe the precise operation of the controllers and that the current ratio is calculated from measurements of the current supplied by the associated generator and measurements of the total current supplied by the two generators.

It may therefore be desirable to provide a power exchange installation that avoids at least some of the above problems and constraints.

### SUMMARY OF THE INVENTION

It is therefore proposed an installation for exchanging power in an aircraft, comprising:
a voltage bus designed to present a bus voltage;
a low-pressure electromechanical converter designed to exchange power between the voltage bus and a low-pressure body of a turbomachine of the aircraft;
a high-pressure electromechanical converter designed to exchange power between the voltage bus and a high-pressure body of the turbomachine of the aircraft; and
for each electromechanical converter, a voltage control module, designed to control the bus voltage by controlling the electromechanical converter in question so as to adjust the power exchanged by the electromechanical converter in question;
characterized in that it further comprises:
a computer designed to provide a sharing setpoint between the exchanged powers, this sharing setpoint varying over time; and
for at least one of the electromechanical converters:
   a communication module designed to receive the sharing setpoint supplied by the computer and an evaluation of the power exchanged by the other of the electromechanical converters, and
   a module for complying with the sharing setpoint, designed to adjust the power exchanged by the electromechanical converter in question so as to comply with the received sharing setpoint, taking into account the received evaluation of the power exchanged by the other of the electromechanical converters.

Thanks to the invention, it is possible to implement a decentralized voltage control, i.e. independent from one electromechanical converter to another, and a distributed power control, i.e. with a sharing of the power exchanged by the electromechanical converters. This sharing may be defined and modified over time using the sharing setpoints. The compliance with this sharing setpoint will prevent the power sharing from drifting.

In particular, the invention is compatible with zero static error voltage control on both sides, ensuring a robustness in the event of loss or failure of control on one side.

A power exchange installation according to the invention may also comprise one or more of the following optional characteristics, in any technically possible combination.

Optionally, the module for complying with the sharing setpoint is designed to adjust the power exchanged by the electromechanical converter in question by modifying a voltage setpoint so that the voltage control module of the electromechanical converter in question controls the bus voltage to the modified bus voltage.

Also optionally, the module for complying with the sharing setpoint is designed to apply, in the voltage control module, a voltage correction to the voltage setpoint.

The fact of applying a correction to a voltage setpoint means that if the sharing setpoint compliance module fails so that it no longer provides a correction (equivalent to zero correction), the DC voltage control module automatically continues to operate by controlling the voltage to the voltage setpoint. This prevents the fault from spreading.

Also optionally, each voltage control module comprises:
a setpoint determination module designed to determine an exchange setpoint for the electromechanical converter in question; and
a control module designed to control the electromechanical converter in question, so that the electromechanical converter in question complies with the exchange setpoint.

Optionally, the exchange setpoint is also a power setpoint to be exchanged between the electromechanical converter in question and the voltage bus.

Also optionally, the exchange setpoint is a current setpoint to be exchanged between the electromechanical converter in question and the voltage bus or, alternatively, the electromechanical converters each comprising an electric machine coupled to the associated body, the exchange setpoint is a torque setpoint for the electric machine.

Optionally, the module for complying with the sharing setpoint is also designed for:
determining a desired exchange setpoint so as to comply with the received sharing setpoint, taking into account the received evaluation of the power exchanged by the other of the electromechanical converters; and
controlling the exchange setpoint of the electromechanical converter in question to the desired exchange setpoint.

Optionally, the module for complying with the sharing setpoint also comprises:
a comparator designed to calculate an error between the desired exchange setpoint and the exchange setpoint; and
a corrector designed to calculate the voltage correction from the error.

Also optionally, the module for complying with the sharing setpoint is designed to determine a desired exchange setpoint so as to comply with the received sharing setpoint by taking into account the received evaluation of the power exchanged by the other of the electromechanical converters, and comprises:
a comparator designed to calculate a difference between, on the one hand, an error between the desired exchange setpoint and the exchange setpoint of the electromechanical converter in question and, on the other hand, an error between the desired exchange setpoint and the exchange setpoint of the other electromechanical converter; and
a corrector designed to calculate the voltage correction from the difference.

Optionally, the corrector has zero static error.

Also optionally, the communication module is further designed to receive an indication of sharing mode from a plurality of predefined sharing modes, and the module for complying with the sharing setpoint is further designed to determine the desired exchange setpoint on the basis of the received sharing mode indication.

Also optionally, the predefined sharing modes comprise at least one of:
a proportional sharing mode, wherein the received power sharing setpoint is a ratio between the exchanged powers and wherein the module for complying with the sharing setpoint is designed to determine the desired exchange setpoint by either multiplying or dividing the received evaluation by the sharing setpoint; and
a differential sharing mode, wherein the received power sharing setpoint is a difference between the exchanged powers, and wherein the module for complying with the sharing setpoint is designed to determine the desired exchange setpoint by adding the received evaluation to the sharing setpoint or by subtracting the received evaluation from the sharing setpoint.

Optionally, the installation also comprises a selection module designed to supply, on command, a so-called direct exchange setpoint to the control module of the electromechanical converter in question, instead of the exchange setpoint, so that the power exchanged by the electromechanical converter in question is controlled to the direct exchange setpoint.

Optionally, the exchange setpoints are also power setpoints to be exchanged.

Also optionally, the evaluation of the power exchanged by the other of the electromechanical converters is the power setpoint to be exchanged of the other of the electromechanical converters.

Also optionally, the evaluation of the power exchanged by the other of the electromechanical converters is a measure of the power exchanged by the other of the electromechanical converters.

A propulsion system for an aircraft comprising a turbomachine and an installation according to the invention is also proposed.

An aircraft comprising a propulsion system according to the invention is also proposed.

A method for exchanging power in an aircraft is also proposed, characterized in that it comprises:
for each of a so-called low-pressure electromechanical converter and a so-called high-pressure electromechanical converter, the low-pressure electromechanical converter being designed to exchange power between a voltage bus designed to present a bus voltage and a low-pressure body of a turbomachine of the aircraft, the high-pressure electromechanical converter being designed to exchange power between the voltage bus and a high-pressure body of the turbomachine of the aircraft, controlling the bus voltage by controlling the electromechanical converter in question so as to adjust the exchanged power;
supplying, by a computer, a sharing setpoint between the exchanged powers, this sharing setpoint varying over time; and
for at least one of the electromechanical converters:
   receiving the sharing setpoint supplied by the computer and evaluating the power exchanged by the other of the electromechanical converters, and
   adjusting the power exchanged by the electromechanical converter in question so as to comply with the received sharing setpoint, taking into account the received evaluation of the power exchanged by the other of the electromechanical converters.

Also proposed is a computer program that may be downloaded from a communication network and/or recorded on a computer-readable medium, characterized in that it comprises instructions for executing the steps of a method according to the invention, when said program is executed on a computer.

### BRIEF DESCRIPTION OF THE FIGURES

The invention will be better understood with the aid of the following description, given only by way of example and made with reference to the attached drawings wherein:

FIG. 1 is a simplified view of a power exchange installation according to the invention in an aircraft,

FIG. 2 is a view similar to FIG. 1, but in a different embodiment,

FIG. 3 is a functional view of a power-sharing compliance module of the installation shown in FIG. 2, for a high-pressure electromechanical converter coupled to a high-pressure body of a turbomachine,

FIG. 4 is a functional view of a power-sharing compliance module in the installation shown in FIG. 2, for a so-called low-pressure electromechanical converter coupled to a low-pressure body of the turbomachine,

FIG. 5 is a functional view of a bus voltage control module of the installation shown in FIG. 2, for the high-pressure electromechanical converter,

FIG. 6 is a functional view of a bus voltage control module of the installation shown in FIG. 2, for the low-pressure electromechanical converter,

FIG. 7 is a functional view of a control module for the electromechanical high-pressure converter in the installation shown in FIG. 2,

FIG. 8 is a functional view of a control module for the low-pressure electromechanical converter in the installation shown in FIG. 2,

FIG. 9 is a similar view to FIG. 1, with selection modules for direct application of setpoints,

FIG. 10 is a similar view to FIG. 9, with the particular case of FIG. 2,

FIG. 11 is a functional view of a power-sharing compliance module of the installation shown in FIG. 1, for the high-pressure electromechanical converter,

FIG. 12 is a functional view of a power-sharing compliance module of the installation shown in FIG. 1, for the high-pressure electromechanical converter,

FIG. 13 is a functional view of variants of the shared respect modules of FIGS. 3 and 4, and

FIG. 14 is a functional view of variants of the sharing compliance modules in FIGS. 11 and 12.

### DETAILED DESCRIPTION OF THE INVENTION

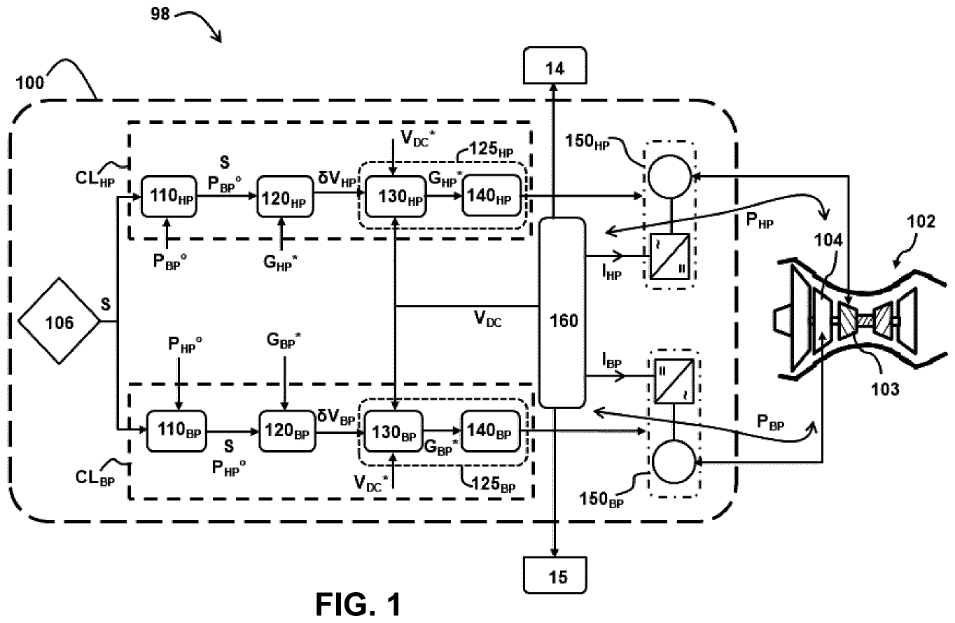

With reference to FIG. 1, an example of a propulsion system 98 for an aircraft, wherein the invention is implemented, will now be described.

The propulsion system 98 firstly comprises a turbomachine 102 comprising a low-pressure body 104 and a high-pressure body 103. The turbomachine 102 is, for example, an aircraft propulsion turbomachine.

The propulsion system 98 also comprises a power exchange installation 100.

The installation 100 comprises a voltage bus 160 and, for example, at least one electrical load 14, 15 connected to the voltage bus 160. Each load 14, 15 corresponds, for example, and without limitation, to one or more items of equipment of the aircraft.

The installation 100 also comprises an electromechanical converter 150_{BP}, referred to as a low-pressure converter, designed to exchange power P_{BP} between the voltage bus 160 and the low-pressure body 104. For example, the low-pressure electromechanical converter 150_{BP} is designed, in a first power transfer direction, to draw mechanical power from the low-pressure body 104 so as to supply electrical power to the voltage bus 160. The low-pressure electromechanical converter 150_{BP} is also designed, for example, in a second power transfer direction, to draw electrical power from the voltage bus 160 so as to supply mechanical power to the low-pressure body 104. To exchange the power P_{BP}, a current I_{BP} is exchanged between the voltage bus 160 and the low-pressure electromechanical converter 150_{BP}.

Similarly, for the high-pressure body 103, the installation 100 also comprises an electromechanical converter 150_{HP}, referred to as a high-pressure converter, designed to exchange power P_{HP} between the voltage bus 160 and the high-pressure body 103. For example, the electromechanical high-pressure converter 150_{HP} is designed, in a first power transfer direction, to draw mechanical power from the high-pressure body 103 so as to supply electrical power to the voltage bus 160. The electromechanical high-pressure converter 150_{HP} is also designed, for example, in a second power transfer direction, to draw electrical power from the voltage bus 160 so as to supply mechanical power to the high-pressure body 103. To exchange the power P_{HP}, a current I_{HP} is exchanged between the voltage bus 160 and the electromechanical high-pressure converter 150_{HP}.

For example, each electromechanical converter 150_{BP}, 150_{HP} comprises an electric machine coupled to the low-pressure body 104 or the high-pressure body 103, respectively, and an AC/DC converter designed to transfer electrical power between the voltage bus 160 and the electric machine. In this way, the electric machine may receive a mechanical torque to generate an alternating current which is rectified by the AC/DC converter to provide the DC bus voltage V_{DC}. The AC/DC converter may also convert the DC voltage V_{DC} to supply AC power to the electric machine so that the latter may provide a mechanical torque to inject power into the turbomachine 102.

The installation 100 also comprises, for each electromechanical converter 150_{BP}, 150_{HP}, a voltage control module 125_{BP}, 125_{HP} designed to control the bus voltage V_{DC} to a voltage setpoint V_{DC}* by controlling the electromechanical converter 150_{BP}, 150_{HP} in question so as to adjust its exchanged power P_{HP}, P_{BP}. The same voltage setpoint V_{DC}* is therefore received by the voltage control modules 125_{BP}, 125_{HP}.

Each voltage control module 125_{BP}, 125_{HP} comprises in particular a setpoint determination module 130_{HP}, 130_{BP} designed to determine an exchange setpoint, noted G_{BP}*, G_{HP}*, of a physical quantity of the electromechanical converter 150_{BP}, 150_{HP} in question, so as to control the bus voltage V_{DC}, this physical quantity being linked to the exchanged power P_{BP}, P_{HP}. In fact, injecting electrical power into the voltage bus 160 tends to increase the bus voltage V_{DC}, while drawing electrical power from the voltage bus 160 tends to decrease the bus voltage V_{DC}. Thus, by adjusting the exchange setpoint G_{BP}*, G_{HP}*, it is possible to modify the exchanged power P_{BP}, P_{HP} so that the electromechanical converter 150_{BP}, 150_{HP} in question injects or withdraws more or less electrical power and therefore modifies the bus voltage V_{DC}.

The exchange setpoint G_{BP}*, G_{HP}* is, for example, a setpoint for the power to be exchanged P_{BP}*, P_{HP}* by the electromechanical converter 150_{BP}, 150_{HP} in question. This is the case that will be developed below.

Alternatively, the exchange setpoint G_{BP}*, G_{HP}* may be a setpoint for the current I_{BP}, I_{HP} between the electromechanical converter 150_{BP}, 150_{HP} in question and the voltage bus 160. When the setpoint V_{DC}* is constant, the bus voltage V_{DC}, which is controlled at this setpoint, also remains substantially constant, so that the current I_{BP}, I_{HP} directly represents the exchanged power P_{BP}, P_{HP},.

Alternatively, the exchange setpoint G_{BP}*, G_{HP}* may be a setpoint for the torque of the electric machine.

Each of the voltage control modules 125_{BP}, 125_{HP} also comprises a control module 140_{BP}, 140_{HP} designed to control the electromechanical low-pressure converter 150_{BP}, respectively high-pressure converter 150_{HP}, so as to control the physical quantity to its exchange setpoint G_{BP}*, G_{HP}*.

The installation 100 also comprises, for at least one of the electromechanical converters 150_{BP}, 150_{HP}, a communication module 110_{BP}, 110_{HP} and a module 120_{BP}, 120_{HP} for compliance with the sharing setpoint. In the example shown, these two modules 110_{BP}, 110_{HP} and 120_{BP}, 120_{HP} are provided for each of the two electromechanical converters 150_{BP}, 150_{HP}.

The communication module 110_{BP}, 110_{HP} is designed to receive a sharing setpoint S between the exchanged powers P_{HP}, P_{BP}, as well as an evaluation P_{BP}°, P_{HP}° of the exchanged power P_{BP}, P_{HP} by the other electromechanical converter 150_{BP}, 150_{HP}.

This evaluation P_{BP}°, P_{HP}° of the power P_{BP}, P_{HP} exchanged by the other electromechanical converter 150_{BP}, 150_{HP} may be, for example, the setpoint of power P_{BP}*, P_{HP}* to be exchanged of the other of the electromechanical converters 150_{BP}, 150_{HP}.

Alternatively, this evaluation P_{BP}°, P_{HP}° may be, for example, a measurement of the power exchanged P_{BP}, P_{HP} by the other of the electromechanical converters 150_{BP}, 150_{HP}.

Based on the data received by the communication module 110_{BP}, 110_{HP}, the module 120_{BP}, 120_{HP} is designed to adjust the power exchanged P_{BP}, P_{HP} by the electromechanical converter 150_{BP}, 150_{HP} in question so as to comply with the received sharing setpoint S, taking into account the received evaluation P_{BP}°, P_{HP}° of the power exchanged P_{BP}, P_{HP} by the other of the electromechanical converters 150_{BP}, 150_{HP}. For example, the module 120_{BP}, 120_{HP} is designed to control the exchange setpoint G_{BP}*, G_{HP}* of the electromechanical converter 150_{BP}, 150_{HP} in question, so as to comply with the sharing setpoint S. To do this, the module 120_{BP}, 120_{HP} is designed, for example, to apply, in the voltage control module 130_{BP}, 130_{HP}, a voltage correction δV_{BP}, δV_{HP} to the voltage setpoint V_{DC}*. Thus, the exchange setpoint G_{BP}*, G_{HP}* is determined by the voltage control module 130_{BP}, 130_{HP} on the basis of the voltage setpoint V_{DC}* corrected by the voltage correction δV_{BP}, δV_{HP}. This voltage correction δV_{BP}, δV_{HP} allows the exchange setpoint G_{BP}*, G_{HP}*, and therefore the exchanged power P_{BP}, P_{HP}, to be modified.

In this way, the control of the bus voltage V_{DC} implemented by the control of the electromechanical converters 150_{BP}, 150_{HP} may be carried out independently of each other, while ensuring that the power sharing follows the setpoint S.

The modules 110_{BP}, 110_{HP}, 120_{BP}, 120_{HP} complement the voltage control modules 125_{BP}, 125_{HP}. The voltage setpoint V_{DC}* is therefore defined independently of the power sharing control implemented by the modules 120_{BP}, 120_{HP}. For example, the voltage setpoint V_{DC}* is supplied by a computer other than the computers CL_{HP}, CL_{BP}.

Still referring to FIG. 1, the installation 100 may comprise independent local computers CL_{BP}, CL_{HP}, associated respectively with the low-pressure electromechanical converter 150_{BP} and the high-pressure electromechanical converter 150_{HP}.

Each local computer CL_{BP}, CL_{HP} thus implements at least the voltage control module 130_{BP}, 130_{HP} and the control module 140_{BP}, 140_{HP} of the associated electromechanical converter 150_{BP}, 150_{HP}. This allows to use a reduced number of computers. Each local computer CL_{BP}, CL_{HP} may also implement the communication module 110_{BP}, 110_{HP} and the module 120_{BP}, 120_{HP} of the associated electromechanical converter 150_{BP}, 150_{HP}.

The installation 100 also comprises, for example, a central computer 106 designed to supply the sharing setpoint S to each communication module 110_{HP}, 110_{BP}.

The central computer 106 is designed, for example, to determine the sharing setpoint S as a function of an operating point (measured and/or estimated, for example on the basis of other measurements) of the turbomachine 102. For example, and without limitation, the operating point may comprise one or more of: the fuel inlet flow rate and/or the air inlet flow rate, a rotational speed of the BP body 104, a rotational speed of the HP body 103, an air inlet temperature and/or fuel inlet temperature and/or exhaust gas temperature leaving the combustion chamber.

Alternatively, the modules 110_{BP}, 120_{BP}, 110_{HP}, 120_{HP} may be implemented in the central computer 106 and not in the local computers CL_{HP}, CL_{BP}.

The following description will develop an implementation example in the particular case where the exchange setpoints G_{BP}*, G_{HP}* are exchange power setpoints P_{BP}*, P_{HP}* and where the evaluations P_{BP}°, P_{HP}° of the exchange powers P_{BP}, P_{HP} are also the exchange power setpoints P_{BP}*, P_{HP}*.

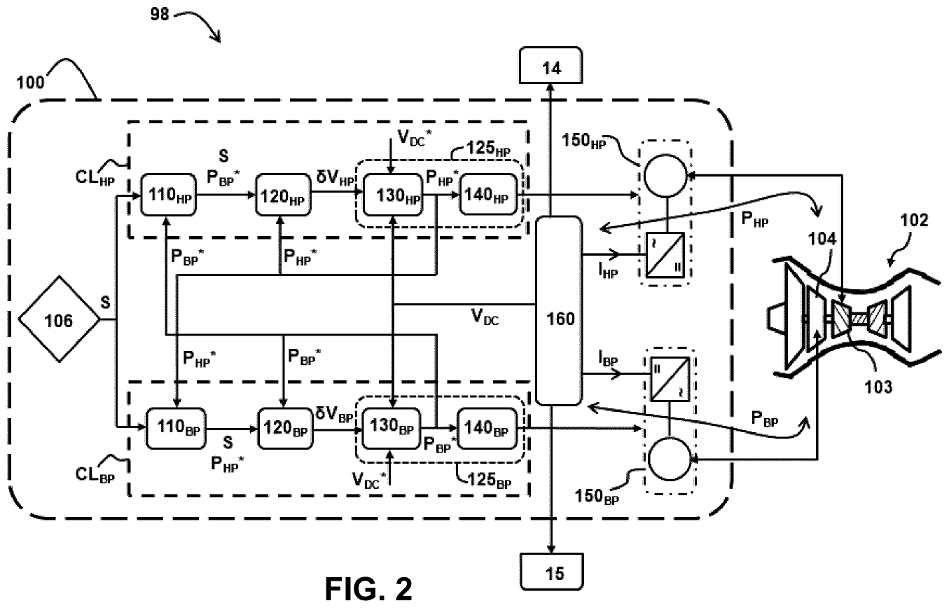

FIG. 2 shows the propulsion system 98 of FIG. 1 in this particular case.

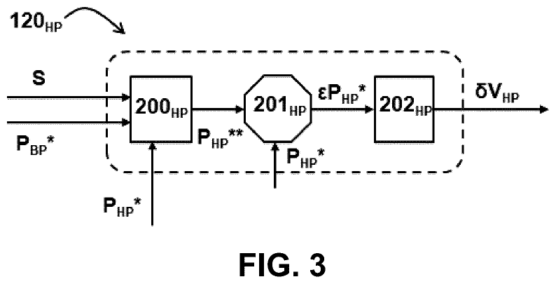

With reference to FIG. 3, the module 120_{HP} comprises a block 200_{HP} for calculating a desired setpoint of power to be exchanged P_{HP}**, from the sharing setpoint S and from the setpoint of power to be exchanged P_{BP}* (taken as the evaluation P_{BP}° of the exchanged power P_{BP}), so as to comply with the sharing setpoint S.

For example, in a so-called proportional sharing mode, the sharing setpoint S may be in the form of a ratio, for example expressed as a percentage, between the exchanged powers P_{BP}, P_{HP}. In this case, the block 200_{HP} is designed to determine the desired setpoint of power to be exchanged P_{HP}** by multiplying or dividing the setpoint of power to be exchanged P_{BP}* by the sharing setpoint S: P_{HP}**=P_{BP}*×S (when S=P_{HP}/P_{BP}) or P_{HP}**=P_{BP}*/S (when S=P_{BP}/P_{HP}).

Alternatively, the ratio may be between one of the exchanged powers P_{BP}, P_{HP} and the sum of the exchanged powers P_{BP}, P_{HP}. The ratio S is therefore in the range [0,1]. In this case, the desired setpoint of power to be exchanged P_{HP}** may be calculated by the block 200_{HP} by multiplying the sum of the exchange setpoints P_{BP}* and P_{HP}* (taken as evaluations P_{BP}°, P_{BP}° of the exchanged powers P_{BP}, P_{HP}) by the sharing setpoint S: P_{HP}**=S×(P_{BP}*+P_{HP}*).

In a so-called differential sharing mode, the sharing setpoint S may be in the form of a difference between the exchanged powers P_{BP}, P_{HP}. In this case, the block 200_{HP} is designed to determine the desired exchange power setpoint P_{HP}** by adding or subtracting the sharing setpoint S to the exchange power setpoint P_{BP}* (taken as the evaluation P_{BP}° of the exchange power P_{BP}): P_{HP}**=P_{BP}*+S (when S=P_{HP}−P_{BP}) or P_{HP}**=P_{BP}*−S (when S=P_{BP}−P_{HP}).

It may be interesting to see the sharing mode change over time. Thus, so as to know this sharing mode and therefore the meaning of the received sharing setpoint S, each communication module 110_{BP}, 110_{HP} may also be designed to receive an indication of the sharing mode identifying the sharing mode from among several predefined sharing modes which comprise, for example, at least one from among the proportional mode and the differential mode presented above.

In this way, the block 200_{HP} is designed to take into account the sharing mode indication in determining the desired power setpoint to be exchanged P_{HP}**. For example, the module 120_{BP}, 120_{HP} is designed to select the formula associated with the indicated sharing mode, this formula giving the desired power setpoint to be exchanged P_{HP}** from the sharing setpoint S and the power setpoint to be exchanged P_{BP}* on the other side (taken as an evaluation of the exchanged power P_{BP} on the other side). For example, the proportional sharing mode is associated with the formula P_{HP}**=P_{BP}*×S (when S=P_{HP}/ P_{BP}) or P_{HP}** =P_{BP}/S (when S=P_{BP}/P_{HP}) or P_{HP}**=S×(P_{BP}*+P_{HP}*) (when S=P_{HP}/ (P_{BP}+P_{HP})), and the differential mode is associated with the formula P_{HP}**=P_{BP}*+S (when S=P_{HP}−P_{BP}) or P_{HP}**=P_{BP}*−S (when S=P_{BP}−P_{HP}).

The module 120_{HP} further comprises a comparator 201_{HP} designed to calculate an error EP_{HP}* between the desired power setpoint to be exchanged P_{HP}** and the power setpoint to be exchanged P_{HP}*, and a corrector 202_{HP} designed to calculate the voltage correction δV_{HP} from the error εP_{HP}*. Preferably, the corrector 202_{HP} has zero static error. For example, the corrector 202_{HP} is of the PI (proportional-integral) or PID (proportional-integral-derivative) type. The use of a corrector allows to avoid the problems associated with the use of a resistance value in the patent application JP 2014 131469 A discussed above.

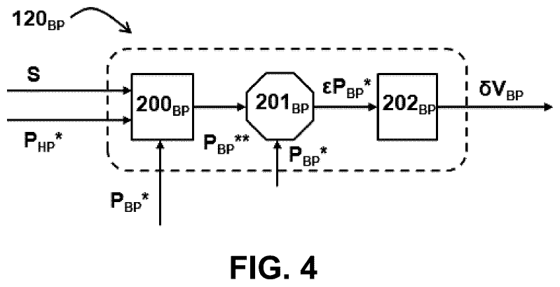

In a similar way, with reference to FIG. 4, the module 120_{BP} comprises a block 200_{BP} for calculating the desired power setpoint to be exchanged P_{BP}** from the sharing setpoint S and the power setpoint to be exchanged P_{HP}* (taken as an evaluation P_{HP}° of the power exchanged P_{HP} on the other side, a comparator 201_{BP} designed to calculate an error εP_{BP}* between the desired power setpoint to be exchanged P_{BP}** and the power setpoint to be exchanged P_{BP}*, and a corrector 202_{BP} designed to calculate the voltage correction δV_{BP} from the error εP_{BP}*.

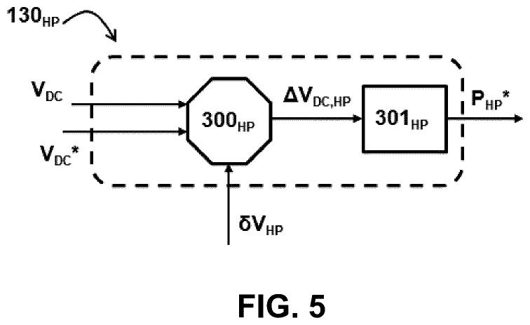

With reference to FIG. 5, the setpoint determination module 130_{HP} comprises a comparator 300_{HP}, designed to calculate a difference ΔV_{DC,HP} between the voltage setpoint V_{DC}* corrected by the voltage correction δV_{HP}, and the bus voltage V_{DC}: ΔV_{DC,HP}=V_{DC}*−δV_{HP}−V_{DC}.

The comparator 300_{HP} may also be configured to calculate a difference ΔV²_{DC,HP} between the square of the voltage setpoint V_{DC}* corrected by the voltage correction δV_{HP}, and the square of the bus voltage V_{D}: ΔV²_{DC,HP}=(V_{DC}*−δV_{HP})²−V²_{DC}.

The setpoint determination module 130_{HP} also comprises a corrector 301_{HP} designed to determine the power setpoint to be exchanged P_{HP}* from the difference V_{DC,HP} or ΔV²_{DC,HP}. Preferably, the corrector 301_{HP} has zero static error. For example, the corrector 301_{HP} is of type PI (proportional-integral) or PID (proportional-integral-derivative).

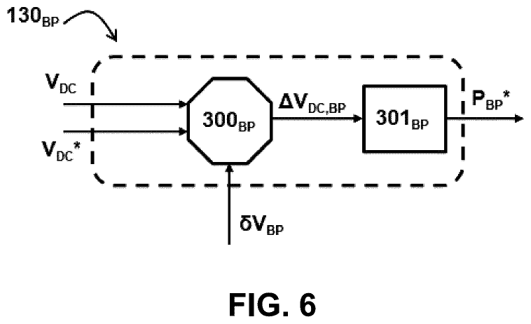

Similarly, with reference to FIG. 6, the setpoint determination module 130_{BP} comprises a comparator 300_{BP} and a corrector 301_{BP}.

The presence of zero static error correctors in the local computers CL_{BP}, CL_{HP} may lead to a discrepancy in power sharing, with one of the electromechanical converters BP or HP taking all the power. In order to control the power sharing between the electromechanical converters BP and HP, the central computer 106 sends sharing setpoints to the local computers CLBp and CLHP of the electromechanical converters 150_{BP}, 150_{HP}. Each electromechanical converter 150_{BP}, 150_{HP} knowing its power and that of the other may then balance the power.

In order to stabilize the power exchanges of the installation 100, each communication module 110_{BP}, 110_{HP} is also designed to implement slow communication, for example and in a non-limiting manner at frequencies lower than 1 kHz and preferably of the order of 1 kHz, so that the balancing loop, formed by the local computers CL_{BP}, CL_{HP} communicating with each other, has a slower bandwidth than the voltage control loop, formed by each local computer CL_{BP}, CL_{HP} and the corresponding electromechanical converter.

The communication module 110_{BP}, 110_{HP} is also designed to implement slow communications, for example and in a non-limiting manner at frequencies of less than 1 kHz and preferably of the order of 1 kHz, between the central computer 106 and the local computers CL_{BP}, CL_{HP}.

The installation 100 is thus designed to be able to operate with a single balancing law active on both (power and voltage balancing), which ensures a redundancy in the event of a loss of communication between the central computer 106 and the local computers CL_{BP}, CL_{HP} and/or a loss of communication between the local computers CL_{BP}, CL_{HP}.

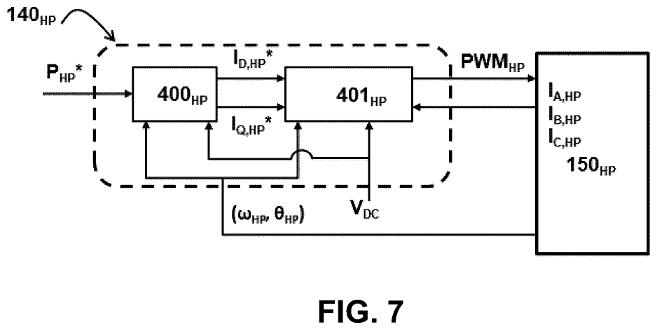

With reference to FIG. 7, the control module 140_{HP} comprises, for example, a block 400_{HP} designed to determine a setpoint for at least one current of the electromechanical converter 150_{HP}, this current or these currents defining the power exchanged P_{HP}. For example, phase currents I_{A,HP}, I_{B,HP}, I_{C,HP} for three phases A, B, and C of the electric machine, expressed in a rotating reference frame equipped with a direct axis and a quadrature axis by direct and quadrature currents. For example, the block 400_{HP} is designed to determine a direct current setpoint I_{D,HP}* and a quadrature current setpoint I_{Q,HP}*. This determination is made, for example, on the basis of an angular position θ_{HP} and a speed of rotation ω_{HP} of a rotor of the electric machine and of the bus voltage V_{DC}.

In particular, the angular position θ_{HP} and the speed of rotation ω_{HP} of the rotor of the electric machine allow to express the electrical quantities, such as the phase currents I_{A,HP}, I_{B,HP}, I_{C,HP}, in the rotating reference frame. The bus voltage V_{DC} is used to modulate phase currents I_{A,HP}, I_{B,HP}, I_{C,HP} or to determine the direct current setpoint I_{D,HP}* using a defluxing method.

The control module 140_{HP} also comprises, for example, a current control block 401_{HP} designed to supply commands to the high-pressure electromechanical converter 150_{HP} on the basis of the current setpoint or setpoints I_{D,HP}*, I_{Q, HP}* and a measurement of this current or these currents, for example the phase currents I_{A,HP}, I_{B,HP}, I_{C,HP}. The controls are pulse width modulation controls PWM_{HP}, for example.

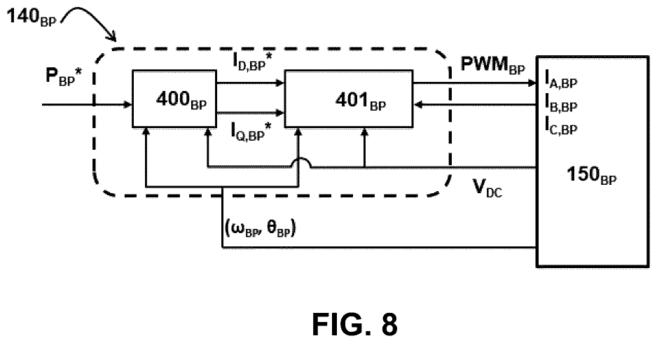

Similarly, with reference to FIG. 8, the control module 140_{BP} comprises, for example, a block 400_{BP} designed to determine a setpoint for at least one current of the low-pressure electromechanical converter 150_{BP}, this current or these currents defining the exchanged power P_{BP}. For example, these are phase currents I_{A,BP}, I_{B,BP}, I_{C,BP} for three phases A, B, and C of the electric machine, expressed as direct and quadrature currents. The block 400_{BP} is designed to determine a direct current setpoint I_{D,BP}* and a quadrature current setpoint I_{Q,BP}*. This determination is made, for example, from an angular position θ_{BP} and a rotation speed ω_{BP} of a rotor of the electric machine and of the bus voltage V_{DC}.

The control module 140_{BP} also comprises, for example, a current control block 401_{BP} designed to supply commands to the low-pressure electromechanical converter 150_{BP} on the basis of the current setpoint or setpoints I_{D,BP}*, I_{Q,BP}* and a measurement of this current or these currents, for example the phase currents I_{A,BP}, I_{B,BP}, I_{C,BP}. The controls are pulse width modulation controls PWM_{BP}, for example.

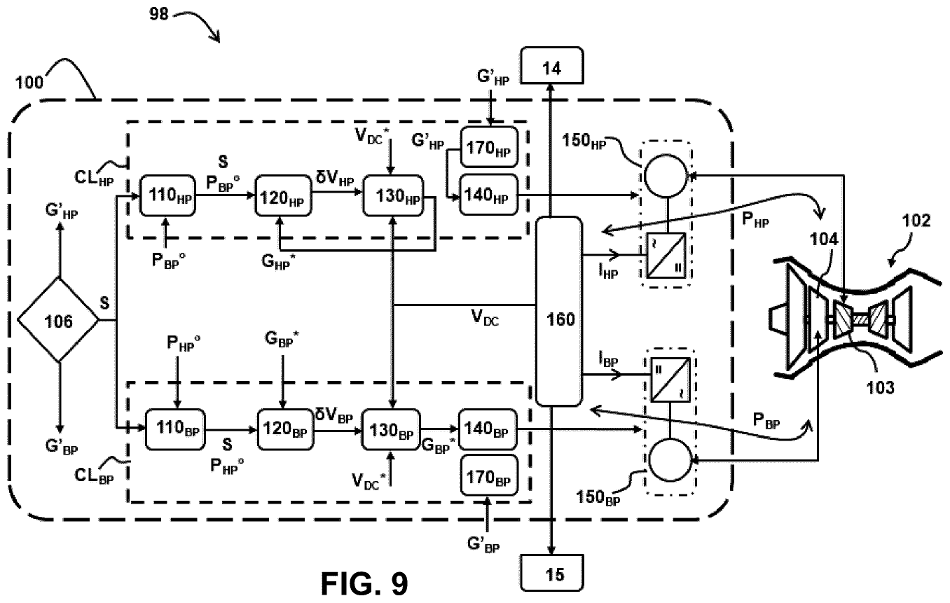

With reference to FIG. 9, the installation 100 may also optionally comprise, for the low pressure side and/or the high pressure side, a selection module 170_{BP}, 170_{HP} designed to receive directly a so-called direct exchange setpoint G′_{BP}, G′_{HP}, for example from the central computer 106, and to supply it selectively to the control module 140_{BP}, 140_{HP}, instead of the exchange setpoint G_{BP}*, G_{HP}* supplied by the module 120_{BP}, 120_{HP}. In this way, the power exchanged by the electromechanical converter 150_{BP}, 150_{HP} in question is directly controlled by the direct exchange setpoint G′_{BP}, G′_{HP}.

In the example shown in FIG. 9, only the selection module 170_{HP} is activated.

On the side where the selection module 170_{HP}, 170_{BP} is activated, the bus voltage is no longer controlled. In this situation, the bus voltage V_{DC} is controlled on the other side.

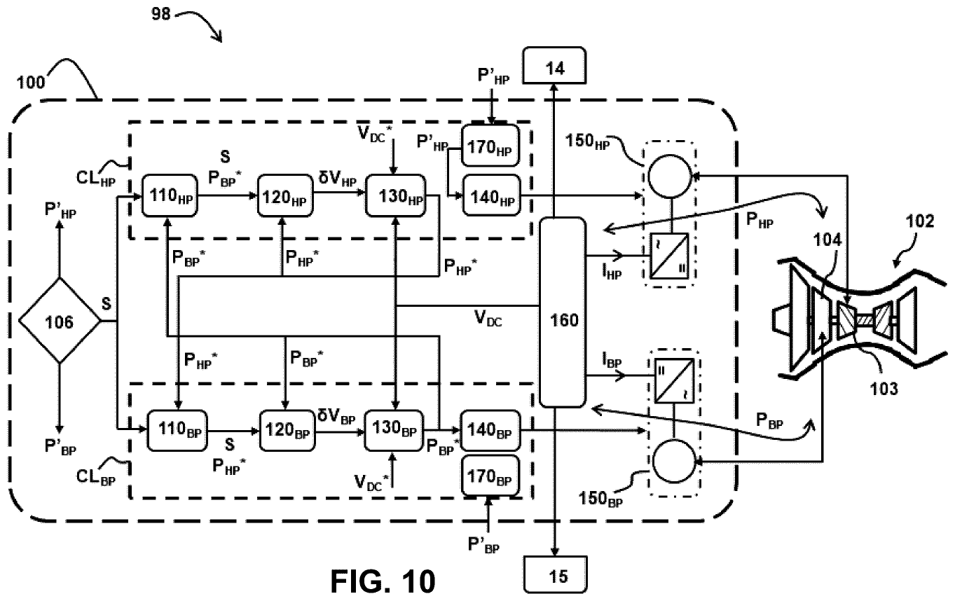

FIG. 10 repeats FIG. 9 in the particular case where the exchange setpoints G_{BP}*, G_{HP}* are exchange power setpoints P_{BP}*, P_{HP}* and where the evaluations P_{BP}°, P_{HP}° of the exchange powers P_{BP}, P_{HP} are also the exchange power setpoints P_{BP}*, P_{HP}*.

In this case, the modules 170BP, 170HP receive power setpoints to be exchanged P′_{BP} or P′_{HP}.

Directly supplying the power exchange setpoint P′_{BP} or P′_{HP}, without having to calculate a voltage correction, allows to define the power exchanges in operating phases where the definition of the power sharing setpoint S is not suitable, for example when the power exchange on one side is fixed and the exchange on the other side is arbitrary. In addition, the direct supply of the power setpoint P′_{BP} or P′_{HP} to be exchanged, allows this setpoint to be applied more quickly, which is useful, for example, in the event of assistance.

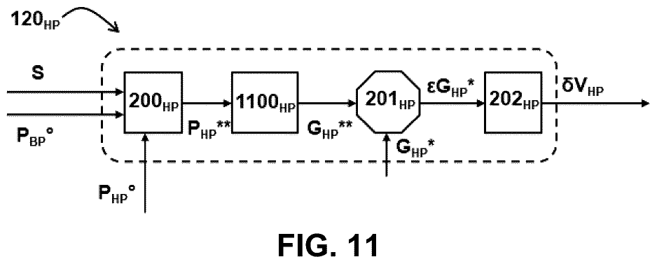

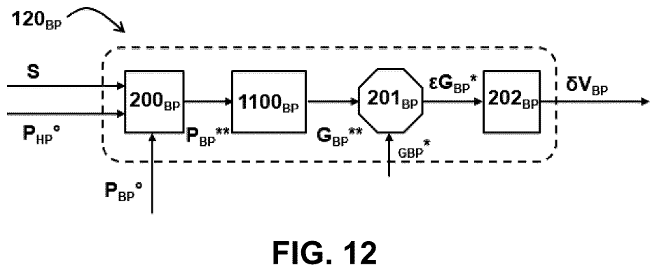

FIG. 11 and FIG. 12 illustrate a possible implementation of the modules 120_{HP}, 120_{BP} in the general case illustrated in FIG. 1. Thus, in this example, the modules 200_{BP}, 200_{HP} are designed to calculate the desired power exchange setpoint P_{BP}**, P_{HP}** from the sharing setpoint S, the evaluation P_{BP}°, P_{HP}° of the power exchanged P_{BP}, P_{HP} on the other side, and if necessary the evaluation P_{BP}°, P_{HP}° of the power exchanged P_{BP}, P_{HP} on the side in question. The modules 120_{HP}, 120_{BP} then also comprise a module 1100_{BP}, 1100_{HP} designed to calculate a desired exchange setpoint G_{BP}**, G_{HP}** from the desired setpoint of power to be exchanged P_{BP}**, P_{HP}**. The comparators 201_{BP}, 201_{HP} are then designed to calculate an error between the desired exchange setpoint G_{BP}**, G_{HP}** and the exchange setpoint G_{BP}*, G_{HP}*, and the correctors 202_{BP}, 202_{HP} (always preferably with zero static error) are designed to calculate the voltage correction δV_{BP}, δV_{HP} from the error.

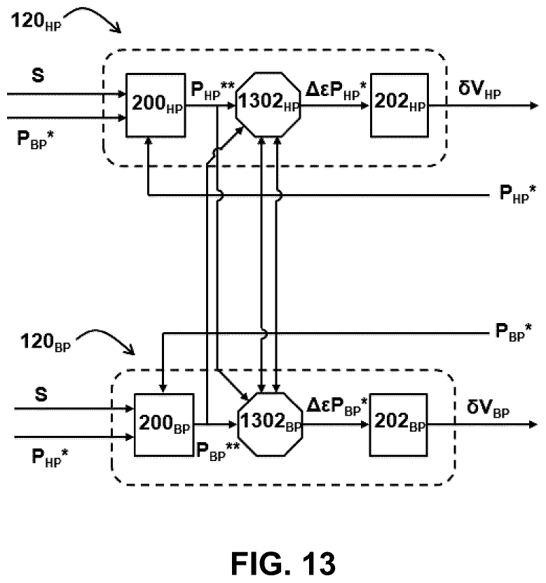

With reference to FIG. 13, in other embodiments, the control of the errors εP_{HP}*, εP_{BP}* of the setpoints P_{HP}*, P_{BP}* may be replaced by a control of the differences of these errors εP_{HP}*, εP_{BP}*.

When there are transient changes on the bus (changes in the electrical load), the bus voltage V_{DC} drifts. However, with the error control εP_{HP}*, εP_{BP}*, it is possible for a power change in the same direction (for example, an increase in the power supplied) to be requested on both the HP side and BP side, but with the sharing remaining constant. This means that the bus voltage may remain at a different level from the desired setpoint V_{DC}* for a long time. By instead controlling the differences in the errors εP_{HP}*, εP_{BP}*, this undesirable side effect is avoided.

Thus, the comparator 201_{HP} may be replaced by a comparator 1302_{HP} designed to calculate the following difference ΔεP_{HP}* between the errors εP_{HP}*, εP_{BP}*: ΔεP_{HP}*=εP_{HP}*−εP_{BP}*=(P_{HP}**−P_{HP}*)−(P_{BP}**−P_{BP}*). Similarly, the comparator 201_{BP} may be replaced by a comparator 1302_{BP} designed to calculate the following difference ΔεP_{BP}* between the errors εP_{HP}*, εP_{BP}*: ΔεP_{BP}*=εP_{BP}*=εP_{HP}*=(P_{BP}**−P_{BP}*)−(P_{HP}**−P_{HP}*).

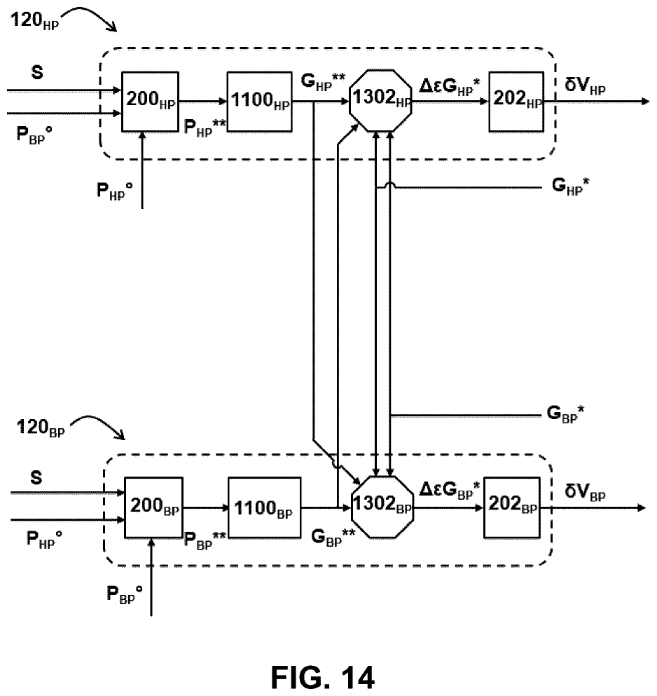

FIG. 14 illustrates a possible implementation of the modules 120_{HP}, 120_{BP} in the general case shown in FIG. 1, with ΔεG_{HP}* and ΔεG_{BP}* the following differences between the errors εG_{HP}*, ΔεG_{BP}*: ΔεG_{HP}*=εG_{HP}*−εG_{BP}*=(G_{HP}**−G_{HP}*)−(G_{BP}**−G_{BP}*) et ΔεG_{BP}*=εG_{BP}*−εG_{HP}*=(G_{BP}**−G_{BP}*)−(G_{HP}**−G_{HP}*).

The desired setpoints G_{HP}**, G_{BP}**, for example, are exchanged via the communication modules 100_{HP}, 110_{BP}.

In conclusion, it should be noted that the invention is not limited to the embodiments described above. In fact, it will appear to the person skilled in the art that various modifications may be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. An installation for exchanging power in an aircraft, comprising:
a voltage bus configured to present a bus voltage (VDC);
a low-pressure (BP) electromechanical converter configured to exchange power (PBP) between the voltage bus and a low-pressure body of a turbomachine of the aircraft;
a high-pressure (HP) electromechanical converter configured to exchange power (PHP) between the voltage bus and a high-pressure body of the turbomachine of the aircraft;
for each of the low-pressure and high-pressure electromechanical converters, a voltage control module configured to control the bus voltage (VDC) by controlling the corresponding electromechanical converter so as to adjust the power exchanged (PHP, PBP) by the electromechanical converter in question;
a computer configured to provide a sharing setpoint (S) between the exchanged powers (PHP, PBP), the sharing setpoint (S) varying over time; and
for at least one of the electromechanical converters
a communication module configured to receive the sharing setpoint (S) supplied by the computer and an evaluation (PBP°, PHP°) of the power exchanged (PBP, PHP) by the other of the electromechanical converters, and
a module configured to comply with the sharing setpoint (S) to adjust the power (PHP, PBP) that is exchanged by the electromechanical converter in question so as to comply with the received sharing setpoint (S), taking into account the received evaluation (PBP°, PHP°) of the power exchanged (PBP, PHP) by the other of the electromechanical converters.

2. The power exchange installation according to claim 1, wherein the module for complying with the sharing setpoint (S) is configured to adjust the power exchanged (PBP, PHP) by the electromechanical converter in question by modifying a voltage setpoint (VDC*) so that the voltage control module of the electromechanical converter in question controls the bus voltage (VDC) to the modified bus voltage.

3. The power exchange installation according to claim 2, wherein the module for complying with the sharing setpoint (S) is configured to apply, in the voltage control module, a voltage correction (δVBP, δVHP) to the voltage setpoint (VDC*).

4. The power exchange installation according to claim 1, wherein each voltage control module comprises:
a setpoint determination module configured to determine an exchange setpoint (GBP*, GHP*) for the electromechanical converter in question; and
a control module configured to control the electromechanical converter in question, so that the electromechanical converter in question complies with the exchange setpoint (GBP*, GHP*).

5. The power exchange installation according to claim 4, wherein the exchange setpoint (GBP*, GHP*) is a power setpoint to be exchanged (PBP*, PHP*) between the electromechanical converter in question and the voltage bus.

6. The power exchange installation according to claim 4, wherein the exchange setpoint (GBP*, GHP*) is a current setpoint to be exchanged between the electromechanical converter in question and the voltage bus or, alternatively, the electromechanical converters each comprising an electric machine coupled to the associated body, the exchange setpoint (GBP*, GHP*) is a torque setpoint of the electric machine.

7. The power exchange installation according to any claim 4, wherein the module for complying with the sharing setpoint (S) is configured for:
determining a desired exchange setpoint (GBP **, GHP ** ) so as to comply with the received sharing setpoint (S), taking into account the received evaluation (PBP°, PHP°) of the power exchanged (PBP, PHP) by the other of the electromechanical converters; and
controlling the exchange setpoint (GBP*, GHP*) of the electromechanical converter in question to the desired exchange setpoint (GBP**, GHP** ).

8. The power exchange installation according to claim 3, wherein the module for complying with the sharing setpoint (S) comprises:
a comparator configured to calculate an error between the desired exchange setpoint (GBP**, GHP** ) and the exchange setpoint (GBP*, GHP*); and
a corrector configured to calculate the voltage correction (δVBP, δVHP) from the error.

9. The power exchange installation according to claim 4, wherein the module for complying with the sharing setpoint (S) is configured to determine a desired exchange setpoint (GBP**, GHP** ) so as to comply with the received sharing setpoint (S) by taking into account the received evaluation (PBP°, PHP°) of the power exchanged (PBP, PHP) by the other of the electromechanical converters and comprises:
a comparator configured to calculate a difference (ΔεGBP*, ΔεGHP*) between, on the one hand, an error (εGBP*, εGHP*) between the desired exchange setpoint (GBP**, GHP** ) and the exchange setpoint (GBP*, GHP*) of the electromechanical converter in question and, on the other hand, an error (εGHP*, εGBP*) between the desired exchange setpoint (GBP**, GHP** ) and the exchange setpoint (GBP*, GHP*) of the other electromechanical converter; and
a corrector configured to calculate the voltage correction (δBP, δVHP) from the difference (ΔεGBP*, ΔεGHP*).

10. The power exchange installation according to claim 8, wherein the corrector has zero static error.

11. The power exchange installation according to claim 7, wherein the communication module is further configured to receive an indication of sharing mode from a plurality of predefined sharing modes, and wherein the module for complying with the sharing setpoint (S) is further configured to determine the desired exchange setpoint (GBP**, GHP** ) on the basis of the received sharing mode indication.

12. The power exchange installation according to claim 11, wherein the predefined sharing modes comprise at least one of:
a proportional sharing mode, wherein the received power sharing setpoint (S) is a ratio between the exchanged powers (PBP, PHP) and wherein the module for complying with the sharing setpoint (S) is configured to determine the desired exchange setpoint (GBP**, GHP** ) by either multiplying or dividing the received evaluation (PBP°, PHP°) by the sharing setpoint (S); and
a differential sharing mode, wherein the received power sharing setpoint (S) is a difference between the exchanged powers (PBP, PHP), and wherein the module for complying with the sharing setpoint (S) is configured to determine the desired exchange setpoint (GBP**, GHP** ) by adding the received evaluation (PBP°, PHP°) to the sharing setpoint (S) or by subtracting the received evaluation (PBP°, PHP°) from the sharing setpoint (S).

13. The power exchange installation according to claim 4, further comprising a selection module configured to supply, on command, a so-called direct exchange setpoint (G′BP, G′HP) to the control module of the electromechanical converter in question, instead of the exchange setpoint (GBP*, GHP*), so that the power exchanged (PBP, PHP) by the electromechanical converter in question is controlled to the direct exchange setpoint (G′BP, G′HP).

14. The power exchange installation according to claim 4, wherein the exchange setpoints (GBP*, GHP*) are power setpoints (PBP*, PHP*) to be exchanged.

15. The power exchange installation according to claim 14, wherein the evaluation (PBP°, PHP°) of the power exchanged (PBP, PHP) by the other of the electromechanical converters is the power setpoint to be exchanged (PBP*, PHP*) of the other of the electromechanical converters.

16. The power exchange installation according to claim 1, wherein the evaluation (PBP°, PHP°) of the power exchanged (PBP, PHP) by the other of the electromechanical converters is a measure of the power exchanged (PHP, PBP) by the other of the electromechanical converters.

17. A propulsion system for an aircraft comprising the turbomachine and the installation according to claim 1.

18. An aircraft comprising a propulsion system according to claim 17.

19. A method for exchanging power in an aircraft, comprising:
for each of a low-pressure (BP) electromechanical converter and a high-pressure (HP) electromechanical converter, the low-pressure electromechanical converter being configured to exchange power (PBP) between a voltage bus configured to present a bus voltage (VDC) and a low-pressure body of a turbomachine of the aircraft, the high-pressure electromechanical converter being configured to exchange power (PHP) between the voltage bus and a high-pressure body of the turbomachine of the aircraft, controlling the bus voltage (VDC) by controlling the electromechanical converter in question so as to adjust the exchanged power (PBP, PHP);
supplying, by a computer, a sharing setpoint (S) between the exchanged powers (PHP, PBP), this sharing setpoint (S) varying over time; and
for at least one of the electromechanical converters;
receiving the sharing setpoint (S) supplied by the computer and evaluating (PBP°, PHP°) the power exchanged (PBP, PHP) by the other of the electromechanical converters, and
adjusting the power exchanged (PHP, PBP) by the electromechanical converter in question so as to comply with the received sharing setpoint (S), taking into account the received evaluation (PBP°, PHP°) of the power exchanged (PBP, PHP) by the other of the electromechanical converters.

20. A computer program that is downloadable from a communication network and/or recordable on a computer-readable medium, the computer program including instructions for executing the steps of a method for exchanging power in an aircraft according to claim 19, when said program is executed on a computer.
